(19) United States
(12) Patent Application Publication
(10) Pub. No.: US 2024/0425721 A1
(43) Pub. Date: Dec. 26, 2024

(54) HYBRID COATING UTILIZING POLYURETHANE RESIN, POLYASPARTIC RESIN AND MONOMERS CAPABLE OF UNDERGOING RING OPENING METATHESIS POLYMERIZATION

(71) Applicant: Advanced Polymer Coatings, Inc., Avon, OH (US)

(72) Inventor: Jeremy Pasatta, Olmsted Falls, OH (US)

(21) Appl. No.: 18/733,035

(22) Filed: Jun. 4, 2024

Related U.S. Application Data
(60) Provisional application No. 63/523,132, filed on Jun. 26, 2023.

(51) Int. Cl. C09D 175/12; C09D 7/48; C09D 7/61; C09D 7/63

(52) U.S. Cl. CPC C09D 175/12; C09D 7/48; C09D 7/61; C09D 7/63

(57) ABSTRACT

A coating composition includes a polyol resin; a polyaspartic resin; monomers capable of undergoing ring opening metathesis polymerization; an isocyanate curing agent; and a metathesis catalyst. The coating composition may further include a solvent; a filler; an adhesion promoter; a rheology modifier; and/or a pigment. The polyol resin may include tetramethyl-1,3-cyclobutanediol. The isocyanate curing agent may include an aliphatic polyisocyanate (e.g., a hexamethylene diisocyanate trimer).

This application claims priority to U.S. Provisional Application Ser. No. 63/523,132 filed Jun. 26, 2023, the contents of which are incorporated by reference herein.

### BACKGROUND

The present exemplary embodiment relates to a hybrid coating composition containing both polyurethane resin, polyaspartic resin and monomers capable of undergoing ring opening metathesis polymerization which is curable at ambient temperature using both an isocyanate curative and ruthenium-based Grubbs catalyst. The hybrid coating shows particularly good flexibility, high gloss, good weathering characteristics, excellent adhesion, compatibility between resins and monomers and with a cure time and rheology that allows the coating to be applied via airless spray application, plural component spray or applied via brush and roller. It finds particular application in exterior applications requiring ambient cure, good flexibility, good gloss and physical appearance and weathering resistance. However, it is to be appreciated that the present exemplary embodiment is also amenable to other like applications.

It would be desirable to develop new coatings that exhibit high flexibility and gloss, good adhesion and excellent weathering resistance while curing at ambient temperature in a short amount of time and shows compatibility between polyurethane resin, polyaspartic resin and monomers capable of undergoing ring opening metathesis polymerization. It is also desirable to develop a coating with said attributes that is capable of being applied via airless spray application, plural component spray or via brush and roller application. Furthermore, it would be desirable to have a coating that meets the requirements outlined and has a greater than 45% filler to reduce costs and improve properties.

### BRIEF DESCRIPTION

Disclosed, in some embodiments, is a coating composition containing polyol resin, polyaspartic resin, and monomers capable of undergoing ring opening metathesis polymerization, fillers and additives, isocyanate curatives, in particular hexamethylene diisocyanate (HDI) trimer-based isocyanate curatives, and a ruthenium-based Grubbs catalyst.

The coating composition may contain any polyol and poyaspartic resin capable of undergoing polymerization with but not limited to an isocyanate-based catalyst. A preferred polyol resin is based on tetramethyl-1,3-cyclobutanediol (TMCD). A preferred isocyanate curative is based on hexamethylene diisocyanate (HDI) based trimer.

Furthermore, the coating composition will contain monomers capable of undergoing ring opening metathesis polymerization. The monomers may include one or more cyclic olefins. Non-limiting examples include dicyclopentadiene and tricyclopentadiene, norbornene and functional norbornene monomers.

Furthermore, the coating may contain an isocyanate curing agent that does not decrease the efficiency of the ring opening methathesis catalyst, and is also capable of curing both the polyol resin and polyaspartic resin. Examples include but are not limited to HDI trimer based isocyanates, but most aliphatic based isocyanates that exhibit good weathering would be suitable for the application.

Furthermore, the coating may contain a filler. Examples include but are not limited to silica, barium sulfate and wollastonite.

Furthermore, the coating may contain a rheology modifier. Examples include but are not limited to hydrophobic fumed silica.

Furthermore, the coating may contain additional additives such as adhesion promoters and flow and levelling additives.

The coating may contain a cure accelerator that reduces drying time. Non-limiting examples include tin based catalysts, such as dibutyltin dilaurate, or organic compounds containing tertiary amines, such as 2,4,6-tris(dimethylaminomethyl) phenol.

In some embodiments, the coating is capable of curing at room temperature in less than 12 hours without the use of the cure accelerator. With the addition of the cure accelerator, the coating may be cured in less than 6 hours. Alternatively, the coating can be additionally cured with heat to improve properties.

Further disclosed are processes for applying a coating. The processes include depositing a coating composition containing the composition described, evaporating the solvent, and curing the epoxy resin.

Disclosed, in some embodiments, is a coating composition containing: a polyol resin; a polyaspartic resin; monomers capable of undergoing ring opening metathesis polymerization; an isocyanate curing agent; and a metathesis catalyst. The coating composition may further include one or more of a solvent; a filler; an adhesion promoter; a rheology modifier; and/or a pigment. In some embodiments, the polyol resin includes tetramethyl-1,3-cyclobutanediol. Optionally, the isocyanate curing agent includes an aliphatic polyisocyanate. The aliphatic polyisocyanate may include a hexamethylene diisocyanate trimer. In some embodiments, the coating composition further includes dibutyl tin dilaurate, a flow and levelling agent, and/or a light stabilizer.

Disclosed, in other embodiments, is a coating composition kit including: (A) a first part containing: a polyol resin; a polyaspartic resin; and monomers capable of undergoing ring opening metathesis polymerization; and (B) a second part containing: a metathesis catalyst; and an isocyanate curing agent. In some embodiments, part (A) further includes one or more of a filler; a flow and levelling agent; a pigment; a rheology modifier; dibutyltin dilaurate; and/or a light stabilizer. Part B may further include a rheology modifier; and/or a flow and levelling agent. Optionally, the filler includes barium sulfate. In some embodiments, the pigment includes titanium dioxide and/or carbon black. The light stabilizer may include a liquid hydroxyphenyl-triazine (HPT) UV absorber and/or a hydroxyphenyl-benzotriazole UV absorber. Optionally, the flow and levelling agent includes a polyacrylate. In some embodiments, parts A and B are formulated at a stoichiometric ratio of 1:1+/−10%. Part A may contain from about 10 to about 40 wt % of the polyol resin, from about 0.1 to about 10 wt % of the polyaspartic resin, and from about 0.1 to about 30 wt % of the monomers capable of undergoing ring opening metathesis polymerization. Optionally, Part A contains from about 15 to about 35 wt % of the polyol resin, from about 0.25 to about 5 wt % of the polyaspartic resin, and from about 1 to about 20 wt % of the monomers capable of undergoing ring opening metathesis polymerization. In some embodiments, part A contains from about 20 to about 30 wt % of the polyol resin, from about 0.5 to about 2.5 wt % of the polyaspartic resin, and from about 2 to about 10 wt % of the monomers capable of undergoing ring opening metathesis polymerization.

These and other non-limiting characteristics are more particularly described below.

### BRIEF DESCRIPTION OF THE DRAWINGS

FIG. 1 is a flow chart illustrating a non-limiting example of a coating process in accordance with some embodiments of the present disclosure.

FIG. 2 is a side cross-sectional view of a coated article in accordance with some embodiments of the present disclosure.

FIG. 3 is a graph showing the effect of dibutyltin dilaurate and Ancamine K54 on gel time.

FIG. 4 is a graph showing the effect of dibutyltin dilaurate and Ancamine K54 on linear dry time.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The present disclosure relates to a coating composition containing a polyol and poyaspartic resin, monomers capable of undergoing ring opening metathesis polymerization, an isocyanate curative, a catalyst capable of initiating ring opening metathesis polymerization

The coating composition is capable of a dual cure mechanism, in which both the polyol and polyaspartic resin are cured by an isocyanate hardener, and the monomers capable of undergoing ring opening metathesis polymerization are cured by a suitable initiator, such as a ruthenium-based Grubbs catalyst. The combination of the two resin systems allows for a hybrid coating that combines the benefits of each technology. Isocyanate cured polyol-based coatings give excellent mechanical properties, good flexibility and good weathering, but tend to be higher in viscosity and need the addition of solvents to be able to be applied by airless and plural component spray, which increases the volatile organic compounds (VOCs). VOCs in coatings are regulated by different governmental agencies, and reducing VOCs has a significant positive impact on the environment and health and safety of those applying the coatings. In addition, coatings prepared from polyurethanes give excellent adhesion to a variety of substrates. Coatings prepared from polyaspartic resins give good physical properties with quick dry times, especially fast hardness development after drying. Coatings prepared from ring opening metathesis polymerization contain excellent flexibility and good hydrophobicity but tend to have poor adhesion. However, monomers capable of ring opening metathesis polymerization have very low viscosity, can effectively act as a reactive diluent, giving the coating the ability to be applied by a variety of different means with the addition of solvent, which reduces the VOCs. By combining the three resins, advantageous properties of all systems can be realized in one coating, giving a coating that has good weatherability, good adhesion, high flexibility and hydrophobicity, excellent mechanical properties and can be easily applied by a variety of mechanisms with reduced VOCs.

Polyol and polyaspartic resins, isocyanates and monomers capable of undergoing ring opening metathesis polymerization can be incompatible, and when mixed together in a coating composition will separate and give an inhomogeneous coating. The present coating formulation overcomes this through careful resin, isocyanate and monomer selection along with selecting the proper ratio of components. Catalysts that are capable of initiating ring opening metathesis polymerization, such as Grubbs catalyst, can be reduced in efficiency by reaction with amines. Therefore, isocyanate and resin selection is critical such that it does not poison the Grubbs catalyst. Examples of isocyanates that accomplish both objectives include but are not limited to HDI based trimers. The isocyanate curing agent should also give dry times less than 6 hours for applications that require fast return to service when used in conjunction with a metal catalyst such as dibutyltin dilaurate. Furthermore, a cure accelerator can be used to further shorten dry times. Selection of the cure accelerator may be important to achieve a good balance between short dry times and longer pot life. If the potlife of the coating is too short, there will be not be sufficient time for the coating to be applied via airless spray. When combined with the Grubbs catalyst, a coating composition that gives good dry times is achievable. The coating composition will also contain a high degree of filler to reduce overall coating cost and improve coating properties. These fillers are commonly known in the industry and examples include but are not limited to silica, barium sulfate and wollastonite. The formulation will also include other coating additives such as fumed silica, adhesion promoters and flow and levelling agents. Coatings made from only monomers capable of undergoing ring opening metathesis polymerization have very short working life, typically on the order of 5 to 15 minutes, which does not make this technology suitable for coatings that are applied via airless or plural component spray or by brush or roller, which require working times of 30 minutes or more. By combining the two curing technologies, working times of greater than 30 minutes are achieved along with viscosity suitable for airless spray applied coatings. The coating should also be formulated in a way that does not allow components to react, does not poison catalysts, and also limits the number of components that need to be mixed together. In order to achieve this, the Grubbs catalyst should be combined in one component of the formulation, and the monomers capable of undergoing ring opening metathesis polymerization should be combined with the polyol and polyaspartic resin in the formulation. Proper separation of the reactive components limits any possibility of premature gelation of the coating formulation.

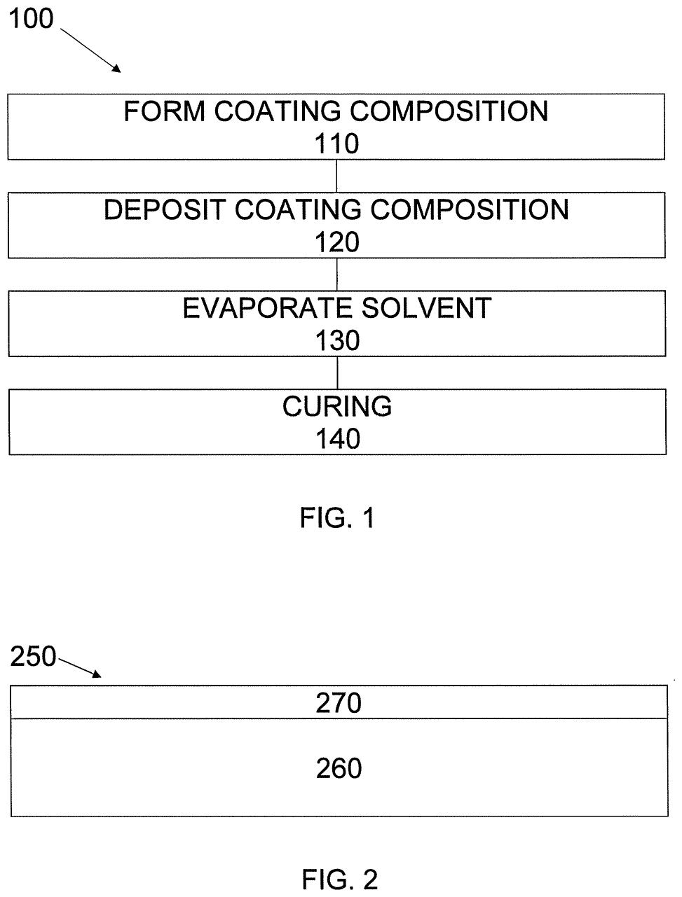

FIG. 1 is a flow chart illustrating a non-limiting example of a coating process 100 in accordance with some embodiments of the present disclosure. The process 100 includes forming a coating composition 110, depositing the coating composition on a substrate 120, evaporating a solvent (if present in the coating composition) 130, and curing the deposited coating composition 140.

In some embodiments, the coating composition is formed 110 by mixing a first part (A) and a second part (B).

The coating composition may be deposited 120 on the substrate using any suitable application step. In particular embodiments, airless spray application is used.

When the coating composition contains a solvent, the solvent may be partially or completely evaporated 130.

Curing 140 encompasses both the amine-curing of the epoxy resin and the ring opening metathesis polymerization.

It should be noted that one or more steps may be repeated to form a coating with a desired thickness.

FIG. 2 is a side cross-sectional view of a coated article 250 in accordance with some embodiments of the present disclosure. The article includes a substrate 260 with a coating layer 270 deposited thereof. The substrate 260 may be a monolayer or a multilayer substrate. The substrate may contain at least one metal element and/or at least one metalloid element. Metal alloys are included herein. The metal(s) may be selected from Li, Be, Na, Mg, Al, K, Ca, Sc, Ti, V, Cr, Mn, Fe, Co, Ni, Cu, Zn, Ga, Rb, Sr, Y, Zr, Nb, Mo, Tc, Ru, Rh, Pd, Ag, Cd, In, Sn, Cs, Ba, La, Ce, Pr, Nd, Pm, Sm, Eu, Gd, Tb, Dy, Ho, Er, Tm, Yb, Lu, Hf, Ta, W, Re, Os, Ir, Pt, Au, TI, Pb, Bi, Po, Fr, Ra, Ac, Th, Pa, Np, Pu, Am, Cm, Bk, Cf, Es, Fm, Md, No, Lr, Rf, Db, Sg, Bh, Hs, Mt, Ds, Rg, Cn, Nh, FI, Mc, and Lv. The metalloid(s) may be selected from B, Si, Ge, As, Sb, and Te. The coating layer 270 is formed from the coating composition described herein and may be formed in a single coating or multiple coatings.

The following examples are provided to illustrate the devices and methods of the present disclosure. The examples are merely illustrative and are not intended to limit the disclosure to the materials, conditions, or process parameters set forth therein.

### EXAMPLES

### Example 1: Enhanced Coating Composition Containing Dual Curing Mechanisms with Standard Drying Times

PART A

| | PERCENT (by weight) | | | |
|---|---|---|---|---|
| COMPONENT | Example | First Range | Second Range | Third Range |
| Tetrashield PC | 26 | 10-40 | 15-35 | 20-30 |
| 4000 (polyol | | | | |
| resin based on | | | | |
| TMCD) | | | | |
| Desmophen | 1.5 | 0.1-10 | 0.25-5 | 0.5-2.5 |
| NH 1520 | | | | |
| (polyaspartic | | | | |
| based resin) | | | | |
| EXP-1961-NI- | 9.3 | 0.1-30 | 1-20 | 2-10 |
| B (Monomers | | | | |
| capable of | | | | |
| undergoing | | | | |
| ring opening | | | | |
| metathesis | | | | |
| polymerization, | | | | |
| specially | | | | |
| blended to give | | | | |
| slow reaction | | | | |
| time) | | | | |
| Cimbar XF | 57.8 | 10-80 | 20-70 | 50-65 |
| (Barium | | | | |
| sulfate) | | | | |
| BYK-354 (Flow | 0.4 | 0-5 | 0.1-2 | 0.1-1 |
| and levelling | | | | |
| agent) | | | | |
| Titanium | 0.9 | 0-10 | 0.1-5 | 0.1-2 |
| dioxide | | | | |
| (Pigment) | | | | |
| Disparalon | 2.7 | 0-15 | 0.5-10 | 1-4 |
| 6900-20X | | | | |
| (Rheology | | | | |
| modifier) | | | | |
| Rockwood | 0.04 | 0-1 | 0.01-0.5 | 0.01-0.1 |
| LB1011 | | | | |
| (Carbon black | | | | |
| pigment) | | | | |
| Dibutyltin | 0.02 | 0-0.5 | 0.01-0.2 | 0.01-0.2 |
| dilaurate | | | | |
| (Polyurethane | | | | |
| and | | | | |
| polyaspartic | | | | |
| catalyst) | | | | |
| Tinuvin 292 | 0.4 | 0-5 | 0.1-2 | 0.1-1 |
| (Light | | | | |
| stabilizer) | | | | |
| Tinuvin 400 | 0.4 | 0-5 | 0.1-2 | 0.1-1 |
| (Light | | | | |
| stabilizer) | | | | |

In addition or as an alternative to DBTDL, other tin or bismuth-based catalysts may be utilized. It should be understood that this catalyst component is not required by may beneficially provide better dry times and/or physical properties.

One or multiple light stabilizers may be utilized. In some embodiments, at least two light stabilizers that work via different mechanisms are utilized.

Tetrashield PC 4000, Desmophen NH 1520, EXP-1961-NI-B, BYK 354, dibutyltin dilaurate, Tinuvin 292 and Tinuvin 400 are combined in a suitable container equipped with a Cowles mixing blade. The components are stirred until homogeneous, approximately 5 minutes. The stirring rate is then increased and the Cimbar XF is slowly added, and this mixture is allowed to stir at high shear rates for 10-15 minutes. After this time, the adhesion titanium dioxide and carbon dioxide are added and allowed to stir at high shear rates for 2-3 minutes. The Disparalon 6900-20X is then added and the mixture is allowed to stir at high shear rates for 10 minutes.

PART B

| | PERCENT (by weight) | | | |
|---|---|---|---|---|
| | | First | Second | Third |
| COMPONENT | Example | Range | Range | Range |
| Desmodur | 96.1 | Stoichiometric to polyol | | |
| N3390A BA/SN | | plus polyaspartic +/− 15% | | |
| (aliphatic | | | | |
| polyisocyanate- | | | | |
| HDI trimer) | | | | |
| EXP-2020F | 1.1 | 0-5 | 0.1-2.5 | 0.5-1.5 |
| (Grubbs catalyst) | | | | |
| EXP-2020A | 0.27 | 0-2 | 0.1-1 | 0.1-0.5 |
| (Grubbs catalyst) | | | | |
| Disparalon 6900- | 2.3 | 0-20 | 5-15 | 8-12 |
| 20X (Rheology | | | | |
| modifier) | | | | |
| BYK-354 (Flow | 0.27 | 0-2 | 0.1-1 | 0.1-0.5 |
| and leveling | | | | |
| agent) | | | | |

Desmodur N3390A BA/SN, EXP-2020-F, EXP-2020A and Byk-354 are added to a mixing vessel equipped with a Cowles type mixing blade and allowed to mix until homogeneous. The Disparalon 6900-20X is slowly added and allowed to mix at high shear rates for an additional 10 minutes.

Part A and Part B are then thoroughly combined to give a coating composition capable of being applied via airless spray with the following properties:

| | |
|---|---|
| Gel time (Shyodu gel timer) | 204 min |
| Sag resistance | 35 mil |

Dry time (linear dry time recorder) 5 hr 47 min hours

### Example 2: Enhanced Coating Composition Containing Dual Curing Mechanisms with Quick Drying Times

PART A

| | PERCENT (by weight) | | | |
|---|---|---|---|---|
| COMPONENT | Example | First Range | Second Range | Third Range |
| Tetrashield PC | 26 | 10-40 | 15-35 | 20-30 |
| 4000 (polyol | | | | |
| resin based on | | | | |
| TMCD) | | | | |
| Desmophen | 1.5 | 0.1-10 | 0.25-5 | 0.5-2.5 |
| NH 1520 | | | | |
| (polyaspartic | | | | |
| based resin) | | | | |
| EXP-1961-NI- | 9.3 | 0.1-30 | 1-20 | 2-10 |
| B (Monomers | | | | |
| capable of | | | | |
| undergoing | | | | |
| ring opening | | | | |
| metathesis | | | | |
| polymerization, | | | | |
| specially | | | | |
| blended to give | | | | |
| slow reaction | | | | |
| time) | | | | |
| Cimbar XF | 57.8 | 10-80 | 20-70 | 50-65 |
| (Barium sulfate) | | | | |
| BYK-354 (Flow | 0.4 | 0-5 | 0.1-2 | 0.1-1 |
| and levelling | | | | |
| agent) | | | | |
| Titanium | 0.9 | 0-10 | 0.1-5 | 0.1-2 |
| dioxide | | | | |
| (Pigment) | | | | |
| Disparalon | 2.7 | 0-15 | 0.5-10 | 1-4 |
| 6900-20X | | | | |
| (Rheology | | | | |
| modifier) | | | | |
| Rockwood | 0.04 | 0-1 | 0.01-0.5 | 0.01-0.1 |
| LB1011 | | | | |
| (Carbon black | | | | |
| pigment) | | | | |
| Dibutyltin | 0.02 | 0-0.5 | 0.01-0.2 | 0.01-0.2 |
| dilaurate | | | | |
| (Polyurethane | | | | |
| and | | | | |
| polyaspartic | | | | |
| catalyst) | | | | |
| Ancamine K54 | 0.17 | 0-0.5 | 0.01-0.3 | 0.01-0.3 |
| Tinuvin 292 | 0.4 | 0-5 | 0.1-2 | 0.1-1 |
| (Light | | | | |
| stabilizer) | | | | |
| Tinuvin 400 | 0.4 | 0-5 | 0.1-2 | 0.1-1 |
| (Light | | | | |
| stabilizer) | | | | |

In addition or as an alternative to DBTDL, other tin or bismuth-based catalysts may be utilized. It should be understood that this catalyst component is not required but may beneficially provide better dry times and/or physical properties.

In addition or as an alternative to Ancamine K54, other organic compounds containing tertiary amines may be used. It will also be appreciated that there are other types of chemistries that can be used to accelerate the curing of polyurethanes.

One or multiple light stabilizers may be utilized. In some embodiments, at least two light stabilizers that work via different mechanisms are utilized.

Tetrashield PC 4000, Desmophen NH 1520, EXP-1961-NI-B, BYK 354, dibutyltin dilaurate, Ancamine K54, Tinuvin 292 and Tinuvin 400 are combined in a suitable container equipped with a Cowles mixing blade. The components are stirred until homogeneous, approximately 5 minutes. The stirring rate is then increased and the Cimbar XF is slowly added, and this mixture is allowed to stir at high shear rates for 10-15 minutes. After this time, the adhesion titanium dioxide and carbon dioxide are added and allowed to stir at high shear rates for 2-3 minutes. The Disparalon 6900-20X is then added and the mixture is allowed to stir at high shear rates for 10 minutes

The amount of dibutyltin dilaurate and Ancamine K54 are varied to give variations in pot life (as measured by gel time) and linear dry time (as measured by a linear dry time recorder)

PART B

| | PERCENT (by weight) | | | |
|---|---|---|---|---|
| | | First | Second | Third |
| COMPONENT | Example | Range | Range | Range |
| Desmodur | 96.1 | Stoichiometric to polyol | | |
| N3390A BA/SN | | plus polyaspartic +/− 15% | | |
| (aliphatic | | | | |
| polyisocyanate- | | | | |
| HDI trimer) | | | | |
| EXP-2020F | 1.1 | 0-5 | 0.1-2.5 | 0.5-1.5 |
| (Grubbs catalyst) | | | | |
| EXP-2020A | 0.27 | 0-2 | 0.1-1 | 0.1-0.5 |
| (Grubbs catalyst) | | | | |
| Disparalon 6900- | 2.3 | 0-20 | 5-15 | 8-12 |
| 20X (Rheology | | | | |
| modifier) | | | | |
| BYK-354 (Flow | 0.27 | 0-2 | 0.1-1 | 0.1-0.5 |
| and leveling | | | | |
| agent) | | | | |

Desmodur N3390A BA/SN, EXP-2020-F, EXP-2020A and Byk-354 are added to a mixing vessel equipped with a Cowles type mixing blade and allowed to mix until homogeneous. The Disparalon 6900-20X is slowly added and allowed to mix at high shear rates for an additional 10 minutes.

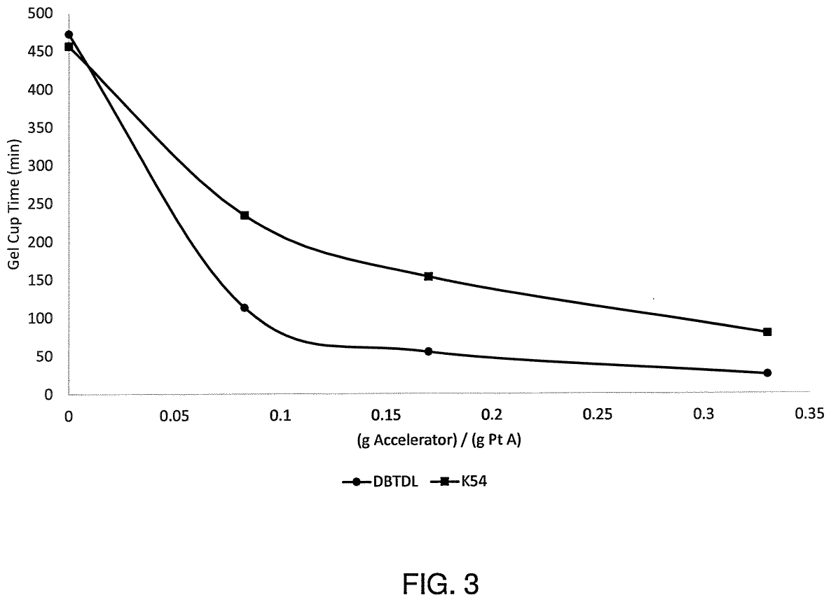

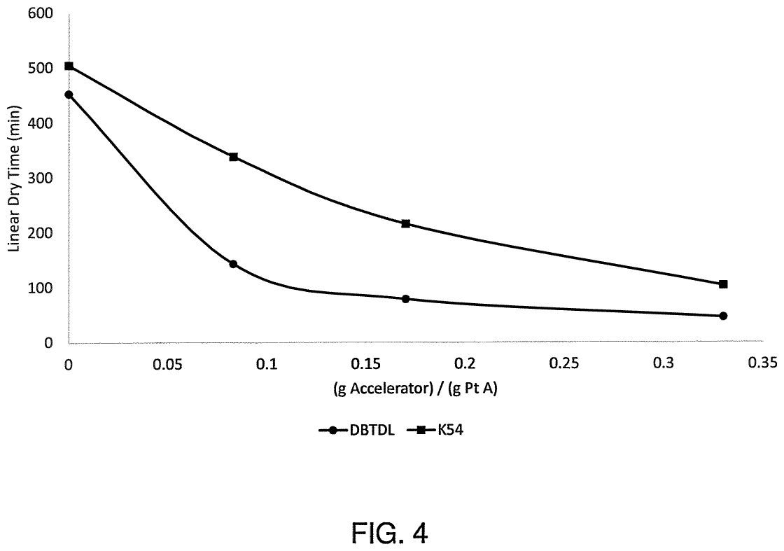

Part A and Part B are then thoroughly combined to give a coating composition capable of being applied via airless spray and were measured for gel time using a Shyodu gel timer and dry time using a linear dry time recorder. FIG. 3 is a graph showing the effect of dibutyltin dilaurate and Ancamine K54 on gel time. FIG. 4 is a graph showing the effect of dibutyltin dilaurate and Ancamine K54 on linear dry time.

FIGS. 3 and 4 show that both cure accelerators are capable of significantly improving dry time, but Ancamine K54 gives a better balance between improved linear dry time and pot life.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A coating composition comprising:
a polyol resin;
a polyaspartic resin;
monomers capable of undergoing ring opening metathesis polymerization;
an isocyanate curing agent; and
a metathesis catalyst.

2. The coating composition of claim 1, further comprising:
a solvent;
a filler;
an adhesion promoter;
a rheology modifier; and
a pigment.

3. The coating composition of any one of claim 1, wherein the polyol resin comprises tetramethyl-1,3-cyclobutanediol.

4. The coating composition of claim 1, wherein the isocyanate curing agent comprises an aliphatic polyisocyanate.

5. The coating composition of claim 4, wherein the aliphatic polyisocyanate comprises a hexamethylene diisocyanate trimer.

6. The coating composition of claim 1, further comprising:
dibutyl tin dilaurate.

7. The coating composition of claim 1, further comprising:
a flow and levelling agent.

8. The coating composition of claim 1, further comprising:
a light stabilizer.

9. The coating composition of claim 1, further comprising:
a cure accelerator.

10. A coating composition kit comprising:
(A) a first part comprising:
a polyol resin;
a polyaspartic resin; and
monomers capable of undergoing ring opening metathesis polymerization; and
(B) a second part comprising:
a metathesis catalyst; and
an isocyanate curing agent.

11. The coating composition kit of claim 10, wherein the first part (A) further comprises:
a filler;
a flow and levelling agent;
a pigment;
a rheology modifier;
dibutyltin dilaurate;
a light stabilizer; and
a cure accelerator.

12. The coating composition kit of claim 10, wherein the second part (B) further comprises:
a rheology modifier; and
a flow and levelling agent.

13. The coating composition kit of claim 11, wherein the filler comprises barium sulfate.

14. The coating composition kit of claim 11, wherein the pigment comprises titanium dioxide and/or carbon black.

15. The coating composition kit of claim 11, wherein the light stabilizer comprises a liquid hydroxyphenyl-triazine (HPT) UV absorber.

16. The coating composition kit of claim 11, wherein the light stabilizer comprises a hydroxyphenyl-benzotriazole UV absorber.

17. The coating composition kit of claim 10, wherein parts A and B are formulated at a stoichiometric ratio of 1:1+/−10%.

18. The coating composition kit of claim 10, wherein part A comprises from about 10 to about 40 wt % of the polyol resin, from about 0.1 to about 10 wt % of the polyaspartic resin, and from about 0.1 to about 30 wt % of the monomers capable of undergoing ring opening metathesis polymerization.

19. The coating composition kit of claim 10, wherein part A comprises from about 15 to about 35 wt % of the polyol resin, from about 0.25 to about 5 wt % of the polyaspartic resin, and from about 1 to about 20 wt % of the monomers capable of undergoing ring opening metathesis polymerization.

20. The coating composition kit of claim 10, wherein part A comprises from about 20 to about 30 wt % of the polyol resin, from about 0.5 to about 2.5 wt % of the polyaspartic resin, and from about 2 to about 10 wt % of the monomers capable of undergoing ring opening metathesis polymerization.
